(19) United States
(12) Patent Application Publication
(10) Pub. No.: US 2015/0157993 A1
(43) Pub. Date: Jun. 11, 2015

(54) Extensional Flow Mixing System

(71) Applicant: West Virginia University, Morgantown, WV (US)

(72) Inventors: Rakesh Gupta, Morgantown, WV (US); Johnny Casasnovas, Grayslake, IL (US); Sushant Agarwal, Morgantown, WV (US); Mahesh Padmanabhan, Buffalo Grove, IL (US); Daoyun Song, Woodbury, MN (US)

(21) Appl. No.: 14/560,514

(22) Filed: Dec. 4, 2014

Related U.S. Application Data
(60) Provisional application No. 61/912,320, filed on Dec. 5, 2013.

(51) Int. Cl. B01F 5/06; A47J 43/07; B01F 3/08; B01F 3/12; A23D 7/00; B01F 3/04

(52) U.S. Cl. CPC B01F 5/0605; A23D 7/00; B01F 3/04985; B01F 3/0807; B01F 3/1271; A47J 43/07; B01F 2215/0022; B01F 2215/0014

(57) ABSTRACT

An extensional flow mixing system is provided comprising a cell including an inlet for introducing fluid into the cell and an outlet permitting fluid to flow out of the cell, the cell having an interior surface defining a convergent flow path that has an internal cross-sectional area that preferably decreases from the inlet to the outlet so as to define a direction of convergence from the inlet to the outlet, and an insert extending within the cell in the direction of convergence, the insert comprising at least one protuberance which causes the fluid to undergo an extensional episode, wherein the protuberance is spaced from the interior surface by a dimension “α” that is constant or changes gradually in the direction of convergence. Method of providing extensional flow and production of dispersions are disclosed.

### CROSS-REFERENCE TO RELATED APPLICATION

This utility patent application claims the benefit of co-pending U.S. Provisional patent Application Ser. No. 61/912,320, filed on Dec. 5, 2013. The entire contents of U.S. Provisional Patent Application Ser. No. 61/912,320 is incorporated by reference into this utility patent application as if fully written herein.

### BACKGROUND OF THE INVENTION

1. Field of the Invention

The invention relates to systems for combining two or more phases of substances such as food or beverage ingredients, and/or creating dispersions, suspensions, mixtures, blends, etc.

2. Description of the Background Art

Shear processing as widely used in industry for creating dispersions, suspensions, mixtures, blends, etc. has certain disadvantages. Shear processing typically requires high energy and physical work to achieve a desired degree of mixing. Due to the high energy input, the resulting product may be heated beyond temperatures at which desirable properties of the product ingredients begin to deteriorate. In the food and beverage industry, a process which uses shear to combine two or more phases of ingredients may thus result in a product with less desirable organoleptic properties. Shear processing may cause texture degradation and off-flavors due to the excessive heat experienced during processing. Loss of functionality (e.g., flavor oxidation or protein denaturation) in sensitive ingredients may occur.

Additional specific issues with shear processing in the food and beverage industry include ingredient sensitivity with respect to e.g., undesirable changes to food matrices such as melt restriction in process cheese, and excessive gluten development in dough processing.

Some dispersions, such as a dispersion of two or more fluids with widely different viscosities, a dispersion of a low viscosity liquid or gas in a high viscosity matrix such as chewing gum or dough, or power hydration at high concentration, are difficult to achieve and/or inefficient with current shear processing technology.

Implementation of new process lines using conventional technologies is hindered by high capital and operating costs.

Extensional flow missing has been suggested as an alternative to shear processing. However, known extensional flow mixing systems having complex geometries can be difficult and expensive to manufacture due to the need for complex machining and/or the number of moving parts. Providing consistent and precise, repeatable adjustment of these devices can also be an issue.

Extensional flow mixing systems that may be suitable for use in connection with certain operations outside of the food and beverage industry, such as for example, operations relating to the manufacture of polymers, may be unsuitable for use in commercial food and beverage operations due to practical issue relating to (1) certain component materials not being suitable for contact with food or beverages; (2) cleaning and sanitation (e.g., compatibility with Clean-in Place (CIP) or Clean-Out-of-Place (COP) procedures); and/or (3) HACCP requirements.

There is a need for improved extensional flow processing solutions for the food and beverage industry and other industries.

### SUMMARY OF INVENTION

There is provided an extensional flow mixing device that avoids the need for some or all of the complex machining required for manufacture of known prior art devices while providing improved functionality.

In one embodiment, the device comprises a cell including an inlet for introducing fluid into the cell and an outlet permitting fluid to flow out of the cell. The cell has an interior surface defining a convergent flow path that has an internal cross-sectional area that decreases from the inlet to the outlet permitting fluid so as to define a direction of convergence from the inlet to the outlet. The extensional flow mixing device includes an insert extending within the cell in the direction of convergence. The insert comprises a protuberance which causes the fluid to undergo an extensional episode. The protuberance is spaced from the interior surface by a dimension “α” that is constant or changes gradually in the direction of convergence.

In another embodiment of this device, as described herein, the cell may be conical, and the protuberance may have a rounded surface, particularly a generally spheroidal surface, spaced from the interior surface of the cell by a minimum dimension of 5 μm≦α≦50 μm, or 15 μm≦α≦40 μm, or about 17 μm≦α≦36 μm. In other embodiments, the protuberance may be spaced from the interior surface by a minimum dimension of 100 μm≦α≦1000 μm, or 300 μm≦α≦700 μm, or 500 μm≦α≦900 μm.

Another embodiment of this invention provides the device of this invention, as described herein, that further comprises a second protuberance which causes the fluid to undergo a second extensional episode upstream or downstream from the first protuberance. The second protuberance may have different geometry from the first protuberance, and may cause fluid in the cell to converge and diverge with a different flow pattern than the first protuberance. The second protuberance may be spaced from the interior surface by a dimension “β,” and may comprise an angled edge on a portion of the protuberance that is closest to the interior surface. Alternatively, both protuberances may have rounded surfaces closest to the cell wall with different radii of curvature.

In other embodiments, there may be provided a single protuberance that has a generally conical or frustoconical outer surface that spaced from the interior surface of the cell by a dimension a that is substantially constant, wherein 5 μm≦α≦60 μm, or 15 μm≦α≦40 μm.

In another embodiment of this invention, the device, as described herein, has a cell that provides a flow cross-section ratio “r” of between about 100 and about 5000, such as about 600 to about 1200, or about 450 to about 3000, wherein r is equal to the ratio of the largest cross-sectional area of flow in the cell to the smallest cross-sectional area of flow.

In embodiments with a single protuberance, the protuberance is preferably adjustable to control the gap between the protuberance and the cell wall. In some embodiments with multiple protuberances, each protuberance is independently adjustable to control the gap dimensions, and thereby control flow cross-section for each protuberance. Alternatively, the protuberances may be adjustable together, so that a single adjustment can enable simultaneous increase or decrease of multiple gap dimensions.

A method of providing extensional flow is also provided. The method comprises the step of providing a cell, including an inlet for introducing fluid into the cell and an outlet permitting fluid to flow out of the cell. The cell may have a convergent portion that has an internal cross-sectional area that decreases from the inlet to the outlet so as to define a direction of convergence from the inlet to the outlet. An insert including a distal end extending within the cell in a direction of convergence is provided. The distal end of the insert comprises one or more protuberances, each defining a space between an interior surface of the cell and the protuberance. At least one fluid is introduced into the cell such that extensional episodes are provided to the fluid in the cell as the fluid flows past the protuberances. Where multiple protuberances are provided, each of the protuberances may produce a different diverging and converging fluid flow pattern. As the fluid exits the cell, an additional extensional episode may be provided at the outlet. The method may be used for preparing edible emulsions.

In some embodiments the fluids may comprise immiscible liquids. In other embodiments, the fluids may comprise at least one gas and one liquid. Some methods may comprise dispersing a solid within at least one fluid.

The fluids in some embodiments may comprise a coarse oil-in-water emulsion comprising, e.g., at least 0.5% oil, or at least 10% oil, such as an edible oil, or more specifically at least 30% soybean oil, or still more specifically about 50% soybean oil, or between about 0.5% to about 95% oil, and may include any suitable emulsifier, including edible emulsifiers such as polysorbate 60, other synthetic emulsifiers, whey proteins, milk proteins, other protein emulsifiers, egg yolk, including salted egg yolk, lecithins such as soy lecithin, and the like. The coarse emulsion may have an average volume-averaged initial droplet size of between about 10 μm to about 100 μm, such as about 10 μm and about 50 μm, or between about 20 μm and about 30 μm. The method may comprise repeatedly providing extensional episodes involving forcing the fluids through a gap of between about 25 μm and about 30 μm to reduce volume-averaged initial droplet size to below 2 μm with a polydispersity index of less than 5.0 while also increasing viscosity. In some embodiments, the cell may have a conical interior, and the insert may comprise a substantially spheroidal surface. In some embodiments, the fluids may be subjected to a total extensional (Hencky) strain of up to eight in a flow dominated by extension and not by shear, at a flow rate of at least about 1.7 liters/min (liters/minute), and up to at least 500 liters/min.

### BRIEF DESCRIPTION OF THE DRAWINGS

FIG. 1 is a schematic view of an extensional flow mixing system in accordance with one exemplary embodiment of the present disclosure.

FIG. 2 is a perspective view of components of two exemplary embodiments of this invention.

FIG. 3 is a schematic view of an exemplary embodiment of this invention.

FIG. 4 is a schematic view of another exemplary embodiment of this invention.

FIG. 5 is a schematic view of another exemplary embodiment of this invention.

FIG. 6 is a schematic view of another exemplary embodiment of this invention.

FIG. 7 illustrates median droplet size as a function of energy density in emulsions prepared with various processes using the device of this invention.

FIG. 8 illustrates median droplet size as a function of energy density in emulsions prepared with selected processes using the device of this invention.

FIG. 9 illustrates median droplet size as a function of energy density in emulsions prepared with selected processes using the device of this invention.

FIG. 10 illustrates median droplet size as a function of energy density in emulsions prepared with selected processes using the device of this invention.

FIG. 11 is a schematic view of an exemplary embodiment of the extensional flow mixing system of this invention.

FIG. 12(a) shows a turbine mixer (Fisher) and FIG. 12(b) shows a rotor-stator mixer (IKA).

FIG. 13 shows optical micrographs of coarse emulsions made using a turbine impeller (left) and that made with a rotor-stator mixer (right).

FIG. 14 shows an embodiment of the cell of the extensional flow mixing system of the present invention wherein a sphere (ball) is placed in the convergence flow section of the cell.

FIG. 15. is a schematic of geometrically similar cells of the extensional flow mixing system of the present invention having various dimensions with Die 5 on the left and Die 2 on the right.

FIG. 16 is a graph that shows emulsion viscosity (y-axis) and shear rate (x-axis) at different cycles using the extensional flow mixing system of the present invention wherein Die 2 at a gap of 25 μm and an insert (plunger) speed of 500 mm/minute.

FIG. 17 is a graph that shows emulsion viscosity (y-axis) and shear rate (x-axis) at different cycles using the extensional flow mixing system of the present invention wherein Die 2 at a gap of 25 μm and an insert (plunger) speed of 500 mm/minute.

FIG. 18 is a graph that shows emulsion viscosity (y-axis) and shear rate (x-axis) at different cycles using the extensional flow mixing system of the present invention wherein Die 2 at a zero gap (0 μm) and an insert (plunger) speed of 500 mm/minute (2.5%).

FIG. 19 is a graph that shows emulsion viscosity (y-axis) and shear rate (x-axis) at different cycles using the extensional flow mixing system of the present invention wherein Die 2 at a zero gap (0 μm) and an insert (plunger) speed of 500 mm/minute (3.5%).

FIG. 20 is a graph that shows emulsion viscosity (y-axis) and shear rate (x-axis) at different cycles using the extensional flow mixing system of the present invention wherein Die 2 at a zero gap (0 μm) and an insert (plunger) speed of 500 mm/minute (5.0%).

FIG. 21 is a graph that shows emulsion viscosity (y-axis) and shear rate (x-axis) at different cycles using the extensional flow mixing system of the present invention wherein Die 4 at a gap of 25 μm and an insert (plunger) speed of 250 mm/minute.

FIG. 22 is a graph that shows emulsion viscosity (y-axis) and shear rate (x-axis) at different cycles using the extensional flow mixing system of the present invention wherein Die 5 is employed under different processing conditions of plunger speed (insert speed), gap lengths, and cycle(s).

FIG. 23 is a schematic that shows an embodiment of the flow cell of the extensional flow mixing system of this invention.

FIG. 24 is a graph that shows the calculated force exerted on the insert (plunger) at plunger speed of 500 mm/min. as a function of gap setting for different liquid viscosities and its comparison with experimental data.

FIG. 25 is a schematic that shows an embodiment of the extensional flow mixing system of this invention having a converging channel of the flow cell that is packed with a material.

FIG. 26. is a depiction as seen through an optical microscope of a corase emuklsion of oil-in-water (volume average diameter about 30 μm.

FIG. 27 is a depiction as seen through an optical microscope of a fine emulsion after passage through the extensional flow mixing system of the present invention having a volume average diameter of about 0.7 μm.

FIG. 28 shows a graph of the particle size distribution of a fine emulsion after one passage through the extensional flow mixing system of the present invention having a volume average diameter of about 0.705 μm.

### DETAILED DESCRIPTION

With extensional flow, droplet and bubble breakage, solids dispersion, and mixing can require less energy than when shearing is relied upon, utilizing a velocity gradient perpendicular to the direction of fluid flow. This results in less viscous dissipation (i.e., less heat generation), allowing emulsions to be formed with lower energy density, i.e., less energy dissipated per unit volume of product formed. Extensional flow mixing devices, including those suitable for preparing dispersions and edible emulsions, and methods of providing extensional flow for combining two or more substances, including gases, liquids, solids, or mixtures thereof, are described below.

In one approach, there is provided an extensional flow mixing device (0) that comprises a cell (1) including an inlet (3) for introducing fluid into the cell and an outlet (5) (orifice) for permitting fluid to flow out of the cell. The cell (1) has an interior surface (7) that may define a convergent flow path, having an internal cross-sectional area that decreases from the inlet (3) to the outlet (5) so as to define a direction of convergence from the inlet in the outlet. In some embodiments, the cross-sectional shape of the convergent flow path defined by the interior surface of the cell (7) may be, e.g., generally square, rectangular, hexagonal, octagonal, or circular. Other cross-sectional shapes may also be employed, and the cross-sectional shape may change along the length of the device. In one embodiment, the cross-sectional shape of the cell is circular along the entire length of the device, and the interior surface is conical.

The cell may be any suitable size capable of processing a volume of fluid(s) at a desired rate, such as for example at least about 1 liter/min (liter/minute), or about 1.7 liters/min, or at larger flow rates of at least about 500 liters/min. The cell may be cylindrical (non-converging), but in the embodiments described below the cell (1) preferably converges at a suitable angle to a central axis of the cell, such as for example about 10° (degrees) to about 80°, or about 30° to about 60°, or about 40° to about 50° C., or about 45°.

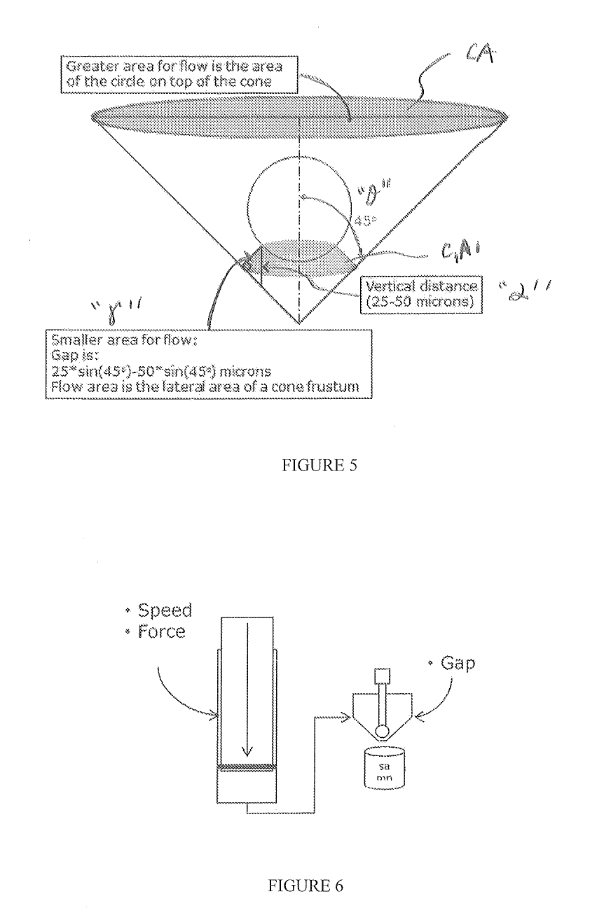

In one approach, an insert (9) extending within the cell in the direction of convergence comprises a protuberance (11) which causes the fluid to undergo an extensional episode, and the protuberance (11) is spaced from the interior surface by a dimension “a” which is constant or changes gradually in the direction of convergence. The dimension “a” is the shortest distance from the cell wall to the protuberance. Adjustment of the distance, may, for example but not limited to, be controlled by an axial screw mechanism (13). Where the system comprises a conical cell with a spherical protuberance disposed therein, the gap dimension may be calculated as the product of the sine of the cone angle and the axial distance that the sphere has been displaced from a zero point at which the spherical protuberance contacts the cell wall, as shown in FIG. 5. In one specific example, shown in FIG. 5, the cone angle is 45°, and the axial distance is between about 25 μm and 50 μm, and the protuberance is spaced from the cell wall by about 17 μm to about 36 μm. This configuration is believed to be suitable for flow rates on the order of, e.g., 1.7 liters/minute. Increased dimensions may be desirable where flow rates are increased. For increased flow rates, dimension “α” may be between about 100 μm to about 1000 μm, such as about 500 μm to 700 μm, or about 500 μm to 900 μm.

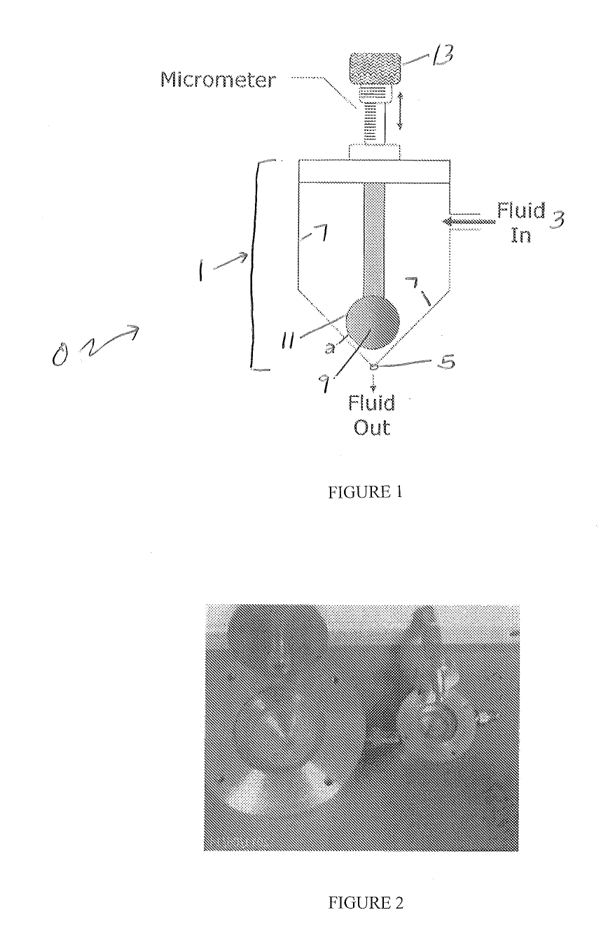

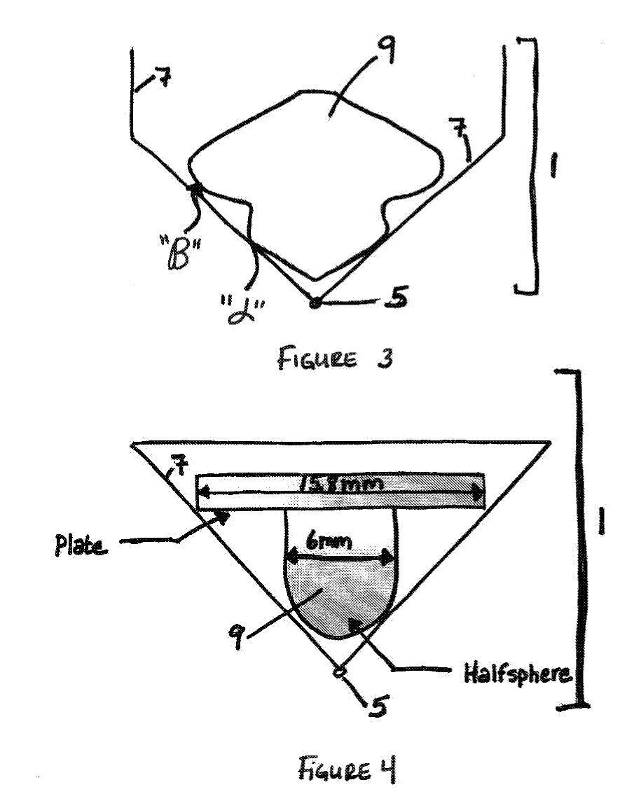

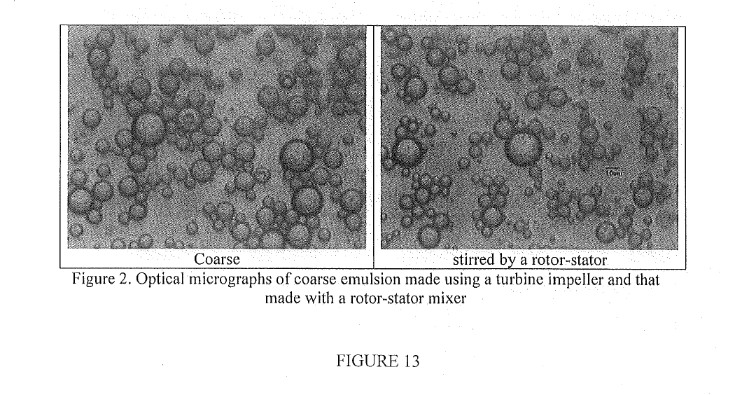

In one embodiment of this invention, the protuberance may be any suitable shape which provides spacing from the interior surface by a dimension that is constant or changes gradually in the direction of flow. In the embodiments illustrated in FIGS. 1 and 5, the protuberance is generally spheroidal, and is spaced from the interior surface by a dimension that changes gradually in the direction of convergence, due to the spheroidal protuberance's curved surface. The spheroidal protuberance may comprise a spherical element such as a stainless steel ball bearing element welded to an axially adjustable stem. In another embodiment as shown in FIG. 11, the protuberance may comprise a generally conical outer surface that is spaced from the interior surface of the cell by a dimension that is substantially constant.

In yet other embodiments, as illustrated in FIGS. 3 and 4, the extensional flow mixing device may comprise more than one protuberance to provide multiple extensional episodes. The additional extensional episodes may be upstream or downstream from the first protuberance. A second protuberance may be spaced from the interior surface by a dimension “β” (FIG. 3). In some approaches, the protuberances each have different geometries, resulting in each protuberance producing a different diverging and converging flow pattern as the fluid flows past the protuberances. As shown in FIG. 4, the insert may comprise at least one protuberance that is rounded on a portion of the protuberance that is closest to the interior surface, and one protuberance that has an angled edge on a portion of the protuberance that is closest to the interior surface. In another embodiment, as illustrated in FIG. 3, the protuberances are both curved. One curved protuberance may have a different radius of curvature than the other protuberance.

As shown in FIG. 5, a two-dimensional area is defined between the interior surface of the cell and the closest portion of the protuberance. In some approaches, the distance between both protuberances and an interior surface of the cell may be adjustable together by changing the degree of extension of the insert into the cell. In other approaches, each protuberance is independently adjustable such that the size of the area defined between the interior surface of the cell and the closest portion of each protuberance may be independently adjusted.

As the fluid flows past one or more protuberances within the cell, the fluid encounters an extensional flow episode at each protuberance, with each extensional episode “stretching” the fluid to decrease droplet size. An additional extensional episode is provided at the outlet of the cell. That is, as the fluid exits the outlet of the cell, the restriction of the outlet also contributes an extensional episode.

In another embodiment of this invention, the extensional flow mixing device provides a flow cross-section ratio (“r”) of between about 100 and about 5000, such as between about 450 and about 3000 or between about 600 to 1200. The flow cross-section ratio is the ratio of the cross-sectional area of the largest cross-sectional area of flow in the cell to the smallest cross-sectional area of flow in the cell, with both cross-sectional areas being in a plane perpendicular to the average local flow velocity at the location of the plane. In one embodiment, as illustrated in FIG. 5, where the cell is cone shaped and comprises a generally spheroidal protuberance, the largest cross-sectional area of flow in the cell is cross-sectional area “CA”. The smallest cross-sectional area of flow in the cell illustrated in FIG. 5 is experienced by the fluid in the cell when the fluid encounters the protuberance. The smallest cross-sectional area “C₁A₁” is the lateral area of the cone frustum defined between the interior surface of the cell and the closest portion of the protuberance. The dimension “γ” between the interior surface of the cell and the protuberance is the shortest perpendicular distance from the interior surface of the cell to the protuberance. In the embodiment of FIG. 5, the cone angle “θ” is 45°, measured from the vertical axis of the cell. The smallest cross-sectional area of flow in the cell is the two dimensional frustoconical area extending perpendicularly from the interior of the cell to the closest portion of the protuberance.

Fluids introduced into the cell may include liquids, solids and/or gases. In one embodiment, immiscible liquids such as oil and water, and specifically an edible oil such as soybean oil, and water, may be introduced. Soybean oil may be introduced, e.g., in an amount of at least about 0.5%, at least about 10%, such as about 50%, or in an amount of between about 0.5% to about 95%. Emulsifiers, including synthetic emulsifiers such as polysorbate 60, proteins such as milk protein, and more specifically whey protein, egg yolk such as salted egg yolk, lecithin such as soy lecithin, and/or the like may also be introduced and used to prepare oil-in-water emulsions and/or water-in-oil emulsions.

Emulsions prepared using the extensional flow mixing device, as described herein, are able to achieve average volume-averaged droplet diameters of less than 2 μm. More specifically, in the methods of this invention, emulsions with droplet diameters reduced to close to 1 μm are achieved by multiple passages through the extensional flow mixing device. Volume-average and number average droplet diameters can be measured with the use of a Shimadsu laser diffraction particle size analyzer. Volume average diameter is calculated for a group of n droplets by multiplying the volume of each droplet by its diameter, and dividing the sum of the products by the total of the volumes of the droplets. This calculation may be expressed as follows:

$${\overline{D}}_{v} = \frac{{\sum }_{i = 1}^{n} {d}_{i} {v}_{i}}{{\sum }_{i = 1}^{n} \sum {v}_{i}}$$

where dᵢ and vᵢ are the diameters and volumes of the droplets 1 through n.

Number averaged droplet diameters are calculated for a group of “n” droplets dividing the sum of the droplet diameters by the number of droplets. The ratio of volume-average to number-average droplet diameters, or polydispersity index, is a reflection of uniformity of droplet sizes.

In some approaches, the fluids introduced into the cell comprise a coarse emulsion, having an average volume-averaged initial droplet size of between about 10 μm to about 100 μm, such as about 10 μm to about 50 μm, or about 20 μm to about 30 μm. Coarse emulsions may be prepared by a turbine impeller, a rotor stator, a valve homogenizer, or other means.

In some embodiments, the fluids may be passed through the extensional flow mixing device repeatedly, to provide extensional episodes which progressively decrease emulsion droplet size until a desired droplet size is achieved. In one approach, the at least one fluid is repeatedly forced to flow through a gap size between a protuberance and an interior surface of the cell of between about 25 μm to about 50 μm. Providing extensional episodes repeatedly allows for reduction of volume average droplet size, such as to a diameter of below about 5 μm, or in some cases below about 2 μm. In some embodiments, a polydispersity index of less than 5, or in some cases less than 3, may be achieved. As the droplet sizes are decreased, the viscosity of the emulsion increases.

In some embodiments, the total extensional strain (Hencky) experienced by the fluid is at least 5, and in some cases is between 5 and 8. The strain experienced by the fluid in the extensional flow mixing device is predominantly extensional strain, and not shear strain.

The extensional flow mixing device of the present disclosure may be used to prepare any suitable dispersion, emulsion, mixture, blend, suspension, or the like. In some approaches, the extensional flow mixing device may be used to prepare food products, such as aerated products, including aerated puddings, foams, marshmallows, and whipped or aerated products such as COOL WHIP®, whipped toppings, MIRACLE WHIP®, dressings and sauces, and aerated cream cheese. Other food products that may be prepared include salad dressings, dairy emulsions, and mayonnaise, as well as products including process cheese and the like which may contain solid ingredients such as gums or proteins, that are dispersed in viscous fluids.

The extensional flow mixing devices and methods described herein may also be used outside of the food and beverage industry, such as in polymer processing. Variations of the components, methods, steps, and devices described in these examples can be used. Unless noted otherwise, all percentages are by weight.

Further detail as to certain embodiments of this invention is provided in the Example section under the heading Emulsions.

### EXAMPLES

### Example I

Median droplet sizes of soybean oil-in-water emulsions using Dispax rotor stator, a valve homogenizer, and the extensional flow cell of FIG. 1 were compared.

Emulsions of soybean oil-in-water using sodium caseinate, salted egg yolk, and polysorbate 60 as emulsifiers were prepared as shown in Table 0 below:

TABLE 0

| | Emulsifier Type | | | |
|---|---|---|---|---|
| | Sodium | Salted | | Salted |
| | Caseinate | Egg Yolk | Polysorbate 60 | Egg Yolk |
| | Formula | | | |
| Emulsifier | 1.0% | 5.0% | 0.5% | 5.0% |
| Water | 19.0% | 15.0% | 19.5% | 45.0% |
| Soybean Oil | 80.0% | 80.0% | 80.0% | 50.0% |

Operating conditions for the Dispax rotor stator, valve homogenizer, and the extensional flow cell of FIG. 1; having a cone angle of 90°; a spherical insert of 12 mm diameter, and a cylindrical plunger having a diameter of 66.6 mm are as follows below:

Rotor Stator (Dispax):
Adjust mass flow rate
Adjust frequency drive to between 5 and 60 Hz
Measure power consumption and collect sample

Valve Homogenizer
Adjust single homogenizing valve to obtain between 250 and 1500 psi
Collect sample

Extensional Flow Cell (Larger Prototype Used)
Adjust axial dimension of gap to 25 or 50 microns
Adjust pumping plunger speed to between 100 and 500 mm/min
Record steady state force and collect sample

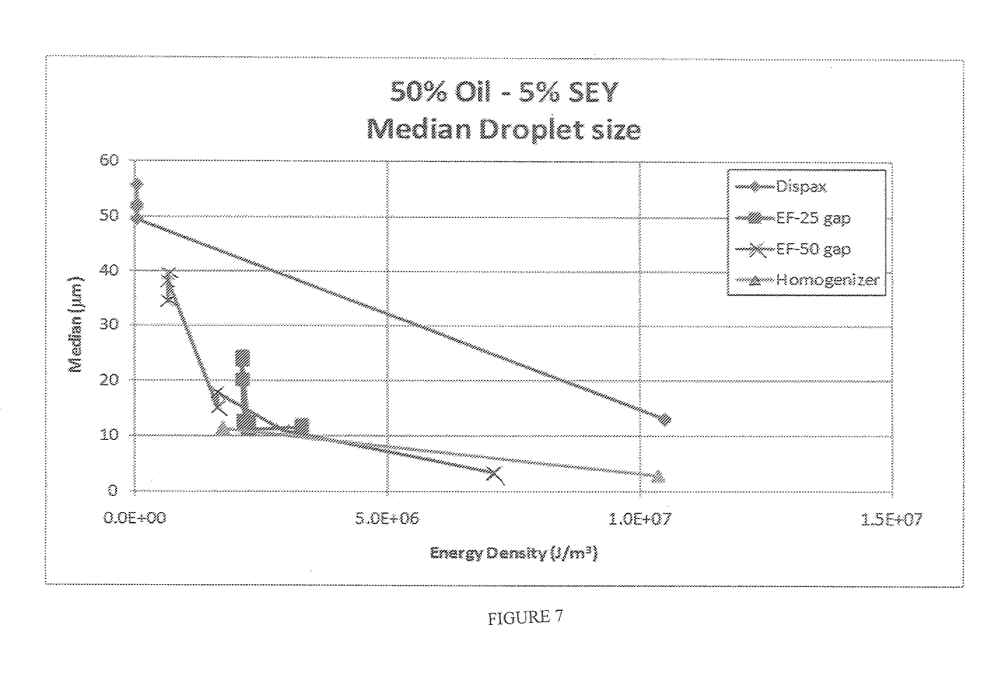

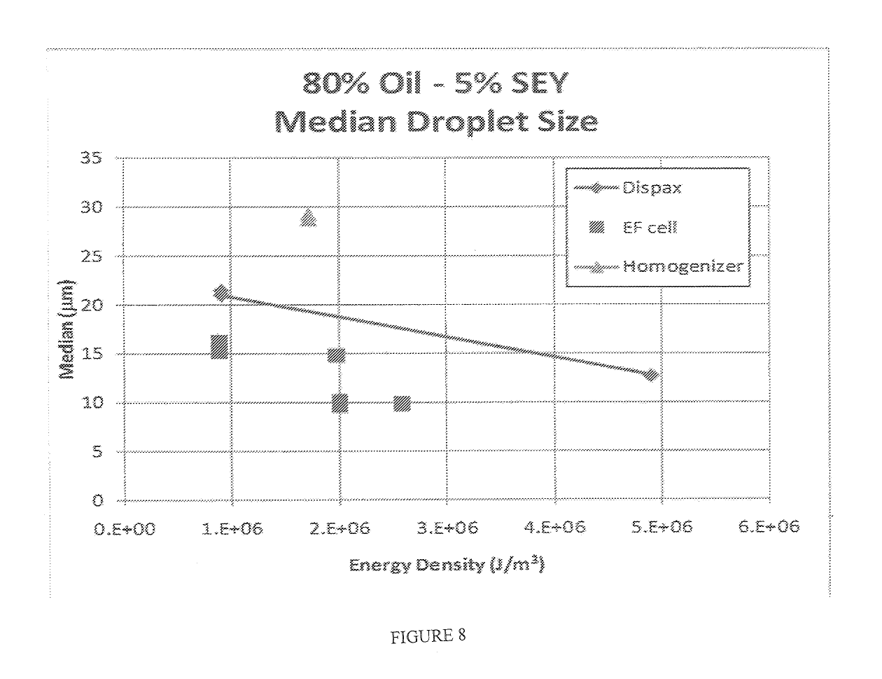

Energy density, which is the energy dissipated by a process per unit volume of product, is calculated for each of the mixing devices as follows:
Energy density is the energy (E) dissipated by a process per unit volume (V) of product
Pressure dissipation devices (e.g. valve homogenizer and EF cell)
   E/V=ΔP
   The valve homogenizer directly measures ΔP
   The ΔP for the EF cell is calculated from the force and the area of the plunger (See, FIG. 6)
Rotor-stator devices (e.g. the Dispax)

$$\frac{E}{V} = ρ \frac{P}{\dot{m}} ,$$

P is power, \dot{m} is mass flow, and p is density
The power needs to be corrected by the amount needed to run the equipment without product.

Median droplet sizes of each emulsion prepared are shown at FIGS. 7-10. FIGS. 7-10 show that extensional flow mixing device of the present disclosure achieved smaller droplets using at most the same, or lower E/V than shear processing. Extensional flow in some cases was able to achieve as low as 40% less energy dissipation than shear processes.

FIG. 7 displays results of a 50% soybean oil in water emulsion with 5% salted egg yolk. Results in FIG. 7 show that in an emulsion of 50% soybean oil in water, oil droplets prepared using the extensional flow mixing device were smaller than droplets prepared using the Dispax rotor (shear process) at the same energy density. Thus, less energy is required using extensional flow to prepare the same droplet size using shear processes. The extensional flow mixing device performs similar to a homogenizer.

FIG. 8 displays results of a 80% soybean oil in water emulsion with 5% salted egg yolk. Most 80% emulsions prepared using the valve homogenizer broke. Oil droplets prepared using the extensional flow mixing device were smaller than droplets prepared using the Dispax rotor (shear process) for the same energy density. Less energy was required using extensional flow to achieve the same droplet size.

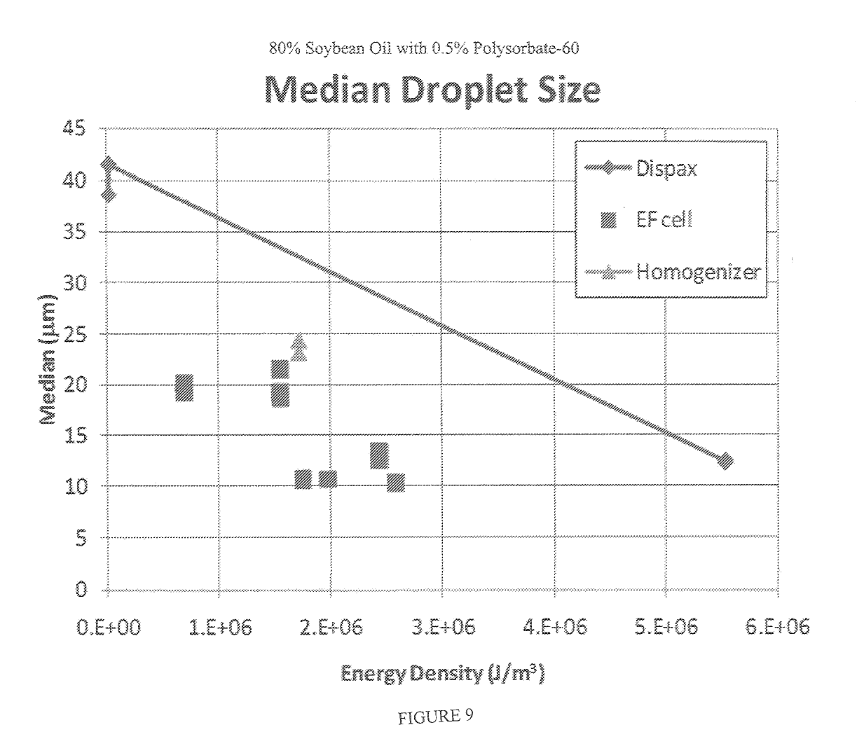

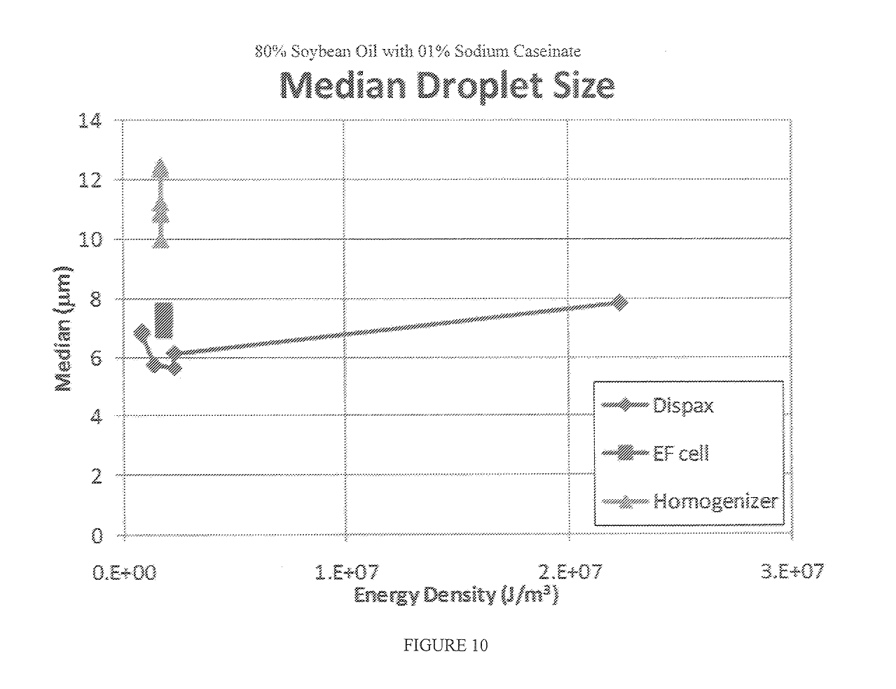

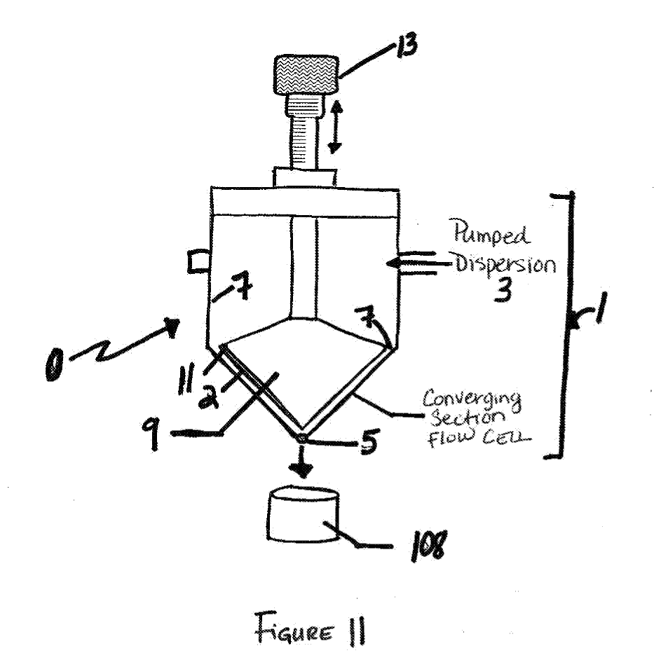

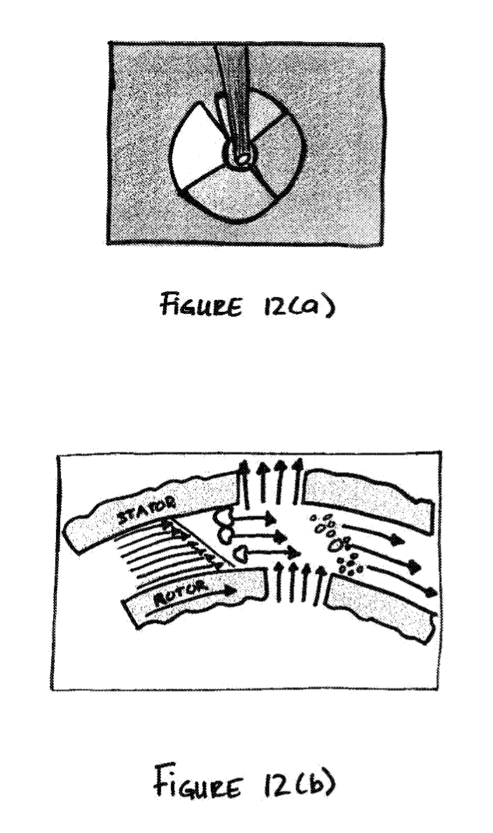

FIG. 9 and FIG. 10 show similar results for other 80% oil emulsions.

### Example II

Those persons skilled in the art shall appreciate that the invention of the present application provides a novel extensional-flow mixing-device, comprising a converging capillary or “cone” and containing a sphere or a disk and sphere combination as inserts that was fabricated to subject liquids to a total extensional strain of about eight. Using a turbine impeller, several coarse soy bean oil-in-water emulsions, containing 50% v (volume) soybean oil, were formulated using polysorbate 60 and whey protein concentrate as emulsifiers. These were made to flow through the cone by forcing liquid out of a reservoir with the help of an Instron® machine. The average volume-averaged initial droplet size, was between 20 μm and 30 μm, and this could be reduced to almost 1 μm by multiple passages through the mixing device; volume-averaged and number averaged drop diameters were measured with the help of a Shimadzu laser diffraction particle size analyzer. Increasing the maximum extension rate either by increasing the flow rate or by reducing the minimum clearance led to progressively smaller dispersed phase sizes. These results were very repeatable, and there was virtually no temperature rise in the process. Also, the resulting emulsion was extremely stable against sedimentation. In addition, the shear viscosity of the fine emulsion could be as much as two orders of magnitude larger than that of the coarse emulsion, especially when the emulsion was forced to flow through clearances of the order of 25 μm. Increasing the amount of emulsifier used resulted in a finer emulsion but one whose viscosity, especially at low shear rates, was substantially higher. It is shown that scale up could be done by building larger, but geometrically similar flow cells.

The present invention shows the inherent advantages of extensional flow over shear flow to formulate oil-in-water emulsions that have a controlled droplet size and size distribution. A table-top extensional flow mixer of this invention was fabricated for formulating emulsions. In this endeavor, computations done using the COMSOL software were also to be used to complement experimental work. These results were then applied to real-world emulsions for example, but not limited to, mayonnaise or other food emulsions of commercial interest.

One embodiment of this invention provides a converging flow capillary attached to the crosshead of an Instron™ machine, wherein it had been demonstrated that drop break up could be achieved when a coarse emulsion was subjected to an extensional flow field by forcing the emulsion through the conical capillary. These emulsions had soy bean oil as the dispersed phase and water as the continuous phase, and they were formulated using three different emulsifiers. These were Polysorbate 60 (PS60), egg yolk and whey protein concentrate (WPC). Key observations were:

1. A single episode of extension and relaxation of a coarse emulsion in the cone does not lead to a significant reduction in dispersed phase size even when the extensional strain is as large as eight. Similarly, there is no size reduction during flow at very large shear rates and in the presence of large shear strains imposed on the emulsion by making it flow through a fine capillary attached to the exit of the cone.

2. A cone containing a variety of inserts can be used to prepare emulsions having an average size that was in the colloidal range. These inserts subjected the emulsion to two stretching episodes.

3. The characteristic gaps in the conical flow cell have to be or the order of 25 to 50 μm to obtain especially stable emulsions. These gaps can be obtained with the use of very fine platinum wires as spacers.

4. The average droplet size of the micron-sized emulsion does not seem to correlate with the measured viscosity of the fine emulsion. Emulsions prepared with the use of a sphere as the insert exhibit a much larger zero-shear viscosity as compared to inserts in the shape of a cone but having a well-defined gap between the insert and the cone wall.

5. Measured and computed pressure drops for flow through the mixing cell are of the same order of magnitude. These numbers may be significantly lower than corresponding values for a homogenizer.

### Emulsions

Coarse emulsions containing 50% v soybean oil and using either whey protein concentrate (WPC) or Polysorbate 60 (PS60) as emulsifiers were prepared using a high speed turbine impeller shown in FIG. 12(a). The agitation speed employed was typically about 1000 rpm. About 12.5 g of WPC was first hydrated, and then 250 g soybean oil was added to the mixture of 12.5 g WPC and 250 g water. Finally the system was agitated for 15 minutes. The WPC concentration, therefore, was 2.5%. The resulting volume average diameter was found to be about 21 μm. Emulsions were also made at other emulsifier contents.

The coarse emulsion made with the turbine impeller was subjected to further mixing using a high speed rotor-stator mixer that is shown in FIG. 12 (b). The mixer operated at 24,000 rpm for 20 seconds. FIG. 13 shows that there is no real reduction in particle size. Similarly, viscosity measurements demonstrated that there was no noticeable difference between the two samples. This happens because the flow is still a shear type flow even when using a rotor-stator mixer. Thus, even though the speed of this mixer is more than one order of magnitude greater than that of the turbine, the dispersed phase sizes are the same.

### Emulsion Characterization

A phase-contrast optical microscope equipped with a digital camera was used to capture images of the emulsions. After calibration, droplet sizes were measured using ScionImage image analysis software. This was a reasonable procedure for the coarse emulsions but not for the fine emulsions since sub-micron sized drops were present. In the latter case, a Shimadzu laser diffraction particle size analyzer was employed to give the complete droplet size distribution; volume average and number average sizes were provided by the software. The accuracy of the laser diffraction particle size analyzer was verified by obtaining the expected results using the standard sample provided by the manufacturer. In addition, the expected size and size distribution of fat particles in milk were measured.

The behavior of the different emulsions was observed as a function of time to see if ripening or phase-separation took place. For stable emulsions, the flow properties were measured using a Carri-Med CSL 100 rotational viscometer.

Converging Flow Cell Geometries of this Invention Employed

The previous converging flow device consisted of a circular tube of diameter of 0.75″ and which tapered down linearly to a fine orifice having a diameter of 0.0135″. A plunger connected to the crosshead of an Instron™ was used to extrude two-phase materials through the converging flow region. By varying the speed of the moving-head, and with the use of inserts of different shapes and sizes, we could obtain a range of stretch rates and stretch rate profiles (at constant total strain). This set up was used to study the emulsification behavior of various model emulsions.

FIG. 11 shows an embodiment of a extensional flow mixing cell of this invention. It is made up of a fixed cone containing a movable insert connected to a micrometer with a least count of 0.001″. Turning the micrometer screw moves the stem of the insert up and down. To set the desired gap, the screw is turned till the insert is pressed tightly against the wall; the gap is now assumed to be zero. Then the screw is turned in the opposite direction to lift the insert to the desired gap as shown by the micrometer gauge. In this design, liquid enters from the side, and this can be achieved with the use of a pump. Note that, as shown, the geometry of FIG. 11 subjects the liquid to two consecutive stretching episodes, but without changing the total strain. Varying the flow rate changes the magnitude of the stretch rate, while changing the cone angle of the insert changes the stretch rate profile and the relative amount of shear and extension. The simplest way to change the total imposed strain is to change the diameter of the circular portion at the top of the flow cell. In order to introduce multiple stretching episodes and also to mimic the commercial extensional flow mixer, inserts of the shape shown in FIG. 3 can be employed; FIG. 3 shows a total of three converging and diverging regions.

The setup of FIG. 11 requires about 100 ml sample volume each time, whereas the old one needed only about 10 ml. An advantage of the large volume is that it is possible for a steady state to be reached during this process. A piston driven injection unit with a capacity of 100 ml was used to force the emulsion through the cell. The piston was driven by an Instron machine where the speed was set and the force (which is proportional to the pressure) was recorded. Experiments were run as a function of piston speed (which is proportional to the flow rate) and the gap setting.

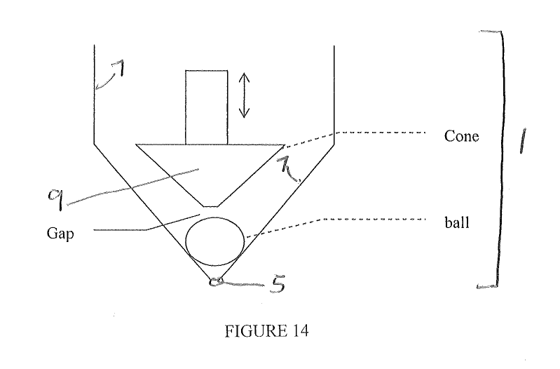

Results of experiments conducted with 50% v soybean oil emulsions made using both WPC and PS60 were disappointing in that no reduction was observed in the droplet size when using the conical insert. The measured forces were small, and it appeared that the gap size was larger than what it should have been. To obtain a better fit between the insert and the cone, the top edge of the insert was machined to make it smoother, and the experiments run again. This time also the results were negative. The situation changed when the conical insert was moved up so there was enough space to place a metal ball (sphere) of 5 mm diameter in the converging channel, see FIG. 14. During emulsion processing, the sphere lifted ever so slightly, allowing flow to take place. The emulsion that emerged was significantly finer. Note that when a sphere is present within the setup, there are three stretching episodes. The first stretching episode is the fluid going through the annulus between the conical insert and the cell wall. The second is in passing around the sphere. The third stretching episode occurs when fluid goes through the exit of the cell.

A schematic diagram of the next version of the converging flow cell is shown in FIG. 1, and this is referred to as Die 2. A spherical insert of 6 mm diameter was machined and then attached to the stem of a micrometer. As in the previous version, the gap between the bottom of the insert and the exit of the cell could be adjusted by turning the micrometer screw. Since the gradations on the micrometer gauge are each 0.001″, the gap setting is accurate to about half this value or 12.5 μm. To set the desired gap, the screw is turned till the insert is pressed tightly against the wall; this setting is assumed to be one with a zero gap. Then the screw is turned in opposite direction in order to lift the insert to desired gap as shown by the micrometer gauge. Flow experiments were performed to determine the effect of the gap setting on emulsification. A coarse emulsion was pumped through the cell using a locally fabricated piston pump attached to the cross head of an Instron® machine. The diameter of the piston was 31.1 mm, and the capacity of the pump was about 100 ml; this allowed for the attainment of a steady state in each run. The control panel of the Instron® machine was used to control the cross head speed and to record the load (proportional to pressure) during pumping. Different pumping speeds were tried, and, as expected, it was found that the best results were obtained at the highest speed of 500 mm/min (flow rate=379.8 cc/min). It was also observed that progressively finer emulsions were obtained as the gap was reduced.

In order to introduce an additional stretching episode, a modified flow cell of this invention is shown in schematic form in FIG. 4, and this is referred to as Die 4. Here, a plate of 15.8 mm diameter was placed above the spherical insert. The dimensions were such that even when the half sphere was completely touching the cone surface, there will still some gap between the edges of the upper plate and the cone surface. This was done to prevent excessive pressure drops that made the flow cell fall apart.

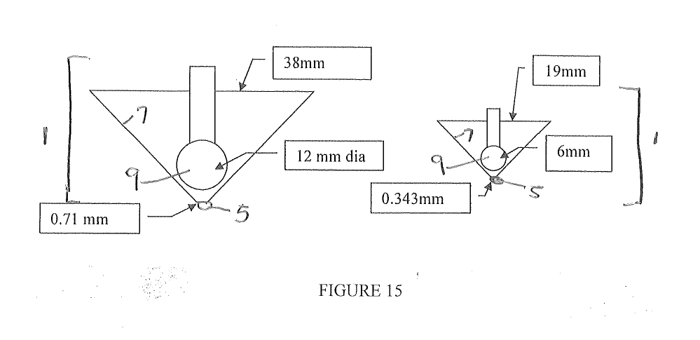

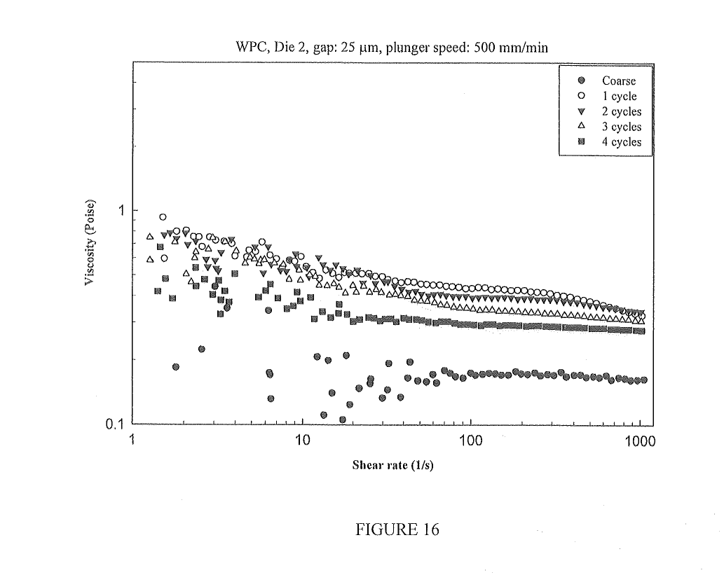

Before concluding the testing of various extensional flow mixing systems of this invention, the largest of the different flow cells of this invention was fabricated and this is referred to as Die 5. This bigger (larger in size flow cell of this invention) flow cell is shown in FIG. 15, and each of its dimensions is twice that of the previous version (Die 2) shown earlier in FIG. 1. As shown in FIG. 15, the two cells are geometrically similar, and, as a result, the total extensional strain in each case is the same. The strain rate, however, depends on the flow rate. The new conical flow cell has an upper diameter of 38 mm which reduces to 0.71 mm at the exit. Since the diameter now is larger, the throughput that can be achieved is also larger. This increase, however, necessitated the construction of a larger diameter piston pump, and the maximum flow rate that can be realized is 1736 cc/min at a piston speed of 500 mm/min. The flow rate is proportionately less at lower piston speeds. An advantage of the larger dimensions is that a small gap of 25 μm can now be set between the cone wall and the spherical insert with a fair degree of accuracy.

### Discussion of Results

Primary goals of this research were to use extensional flow to reduce the average size of a coarse emulsion formulated using shear mixing and to change the size distribution of the fine emulsions that were made from the same coarse emulsion. Two different conical flow cells were employed (Die 2 and Die 4): both contained the same spherical insert, but one had a disk-like insert above the sphere to provide an additional stretching episode. Effects of the presence of the disk, the gap between the spherical insert and the cone, the emulsifier concentration and number of recirculation cycles on the particle size distribution were investigated in a quantitative manner.

In general, it was found that there was a clear relationship between the gap between the insert and the cone wall and the emulsion droplet size. Narrowing the gap resulted in a progressively finer emulsion. If the chosen gap was too small, though, the pressure inside the cell became excessive, and the cell fell apart. A gap of 25 μm was found to be both safe and effective in producing a fine emulsion. Similarly, increasing the flow rate, brought about by increasing the plunger speed, also led to smaller droplet sizes.

Results obtained with the use of Die 2 and Die 4 at a gap setting of 25 μm and a plunger speed of 500 mm/min (the maximum possible speed) are given in Tables 1 and 2 respectively. These tables list both the volume-average and number-average diameters, and it is evident that using Die 4 leads to slightly smaller particle sizes. The polydispersity index, defined as D̅ᵥ/ D̅ₙ, also appears to be smaller (on average) with the use of Die 4. Thus, the use of a disk above the sphere does seem to influence both the size and size distribution of the fine emulsions. Another observation is that the mean particle size decreases and the size distribution narrows with each recirculation of the emulsion through the flow cell. However, there are diminishing returns with continued recirculation of the fluid. The smallest volume-average diameter obtained in all our work was slightly larger than 1 jam, and the polydispersity index was 2.

Note that, even at a gap of 50 μm, the use of Die 4 gives results similar to those obtained at the gap of 25 μm as shown in Table 3. Recirculation of fluid appears to break down the larger drops and yields a smaller volume-average diameter without altering the number-average diameter. In some cases, though, repeated recirculation may also result in coalescence and an increase in the number-average diameter.

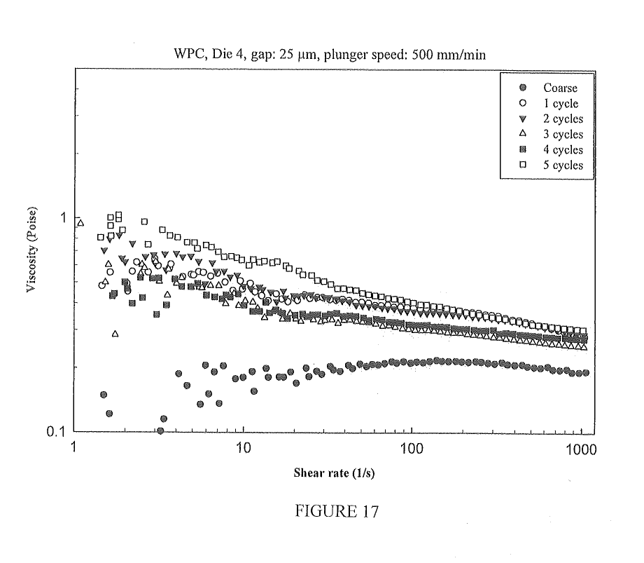

The fine emulsions produced using extensional flow were remarkably stable and no phase separation was observed even after several months of storage. Indeed, they seemed to possess a yield stress, and this could be the reason why there was no creaming or settling of the dispersed phase. The measured viscosity values are presented in FIG. 9 for Die 2 and FIG. 17 for Die 4. It is evident that the flow curves of all the fine emulsions lie significantly above the flow curve of the coarse emulsion. Not being limited to any particular theory, however, the trend with multiple cycling is not as straightforward.

In order to determine if the amount of emulsifier ordinarily used could limit the ability to form small drops when severe mixing conditions are used, WPC emulsions with three emulsifier concentrations were used. These are 2.5%, 3.5% and 5.0%, respectively. Notice that if the emulsifier concentration is not specified, it is 2.5%. The other conditions are: use of Die 2 at minimum gap and a plunger speed of 500 mm/min. The average particle sizes measured in each case are listed in Tables 4-6. It is found that for each of the three emulsifier concentrations, the dispersed phase become smaller with recirculation. At the normal emulsifier concentration, the minimum volume-average diameter is about 2 microns after recirculation, as listed in Table 4. The minimum achievable volume-average particle sizes were reduced to 1.8 and 1.3 microns respectively at surfactant concentrations of 3.5% and 5.0%, as shown in Tables 5 and 6. One would expect this reduction to occur. The minimum ploydispersity index in each case is around 2.

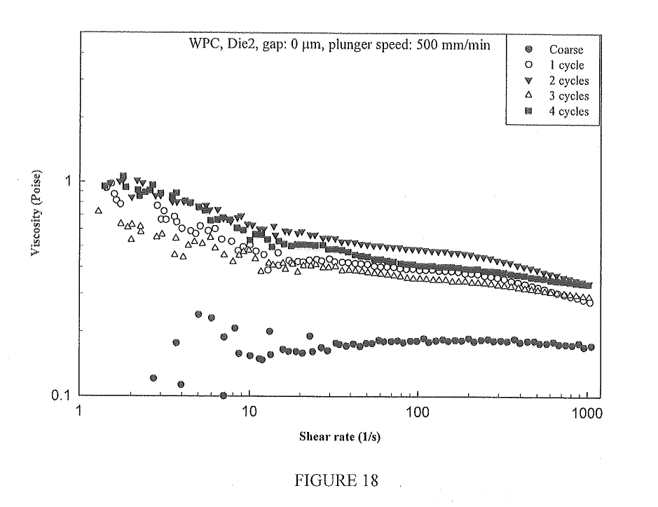

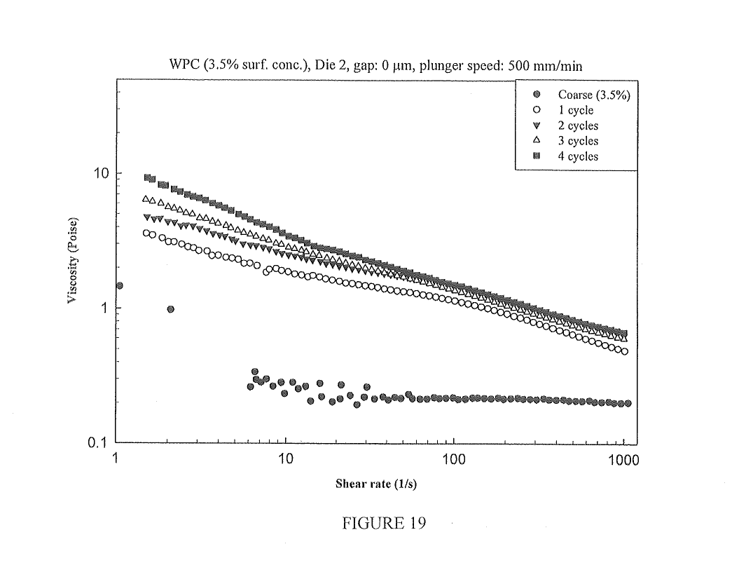

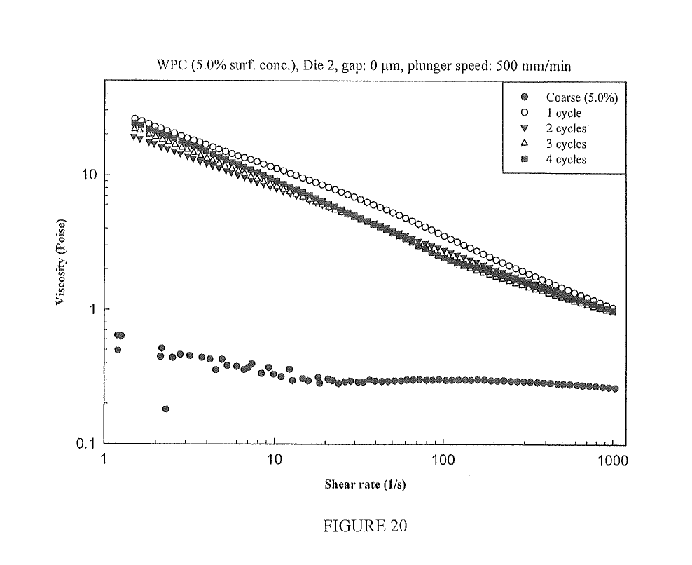

While the higher emulsifier concentration appears to be beneficial in forming emulsions with smaller particle sizes, this may come at the expense of a higher viscosity, especially at low shear rates. Measured viscosity values are shown in FIGS. 18-20. It is found that increasing the emulsifier concentration from 2.5 to 3.5% does not increase the viscosity of the coarse emulsion. However, there is a very significant enhancement in viscosity of the fine emulsions. Also, the viscosity increases with each pass through the mixer. At the highest surfactant concentration, though, there is an increase in the viscosity of the coarse emulsion. This increase in viscosity is probably due to the presence of free emulsifier in the emulsion.

The above work was repeated using different amounts of PS 60 emulsifier. Die 2 with minimum gap was used to formulate the fine emulsions. Three different coarse emulsions were used, and these contained 0.5, 1 and 2 wt % PS60. Samples were run through the cell and recycled for up to 4 times. The measured size analysis is given in Table 7. It can be seen that only for the emulsions containing 0.5% PS60 is there no reduction in particle size on recycling. If anything, the droplet size seems to increase. This may be due to the fact that at the 0.5% level, not enough surfactant is available to stabilize the smaller particles and they grow in size due to coalescence. However, for 1 wt % and 2 wt % PS60 concentration, there is a progressive decrease in droplet size with each recycling step, and the smallest size is obtained for 2 wt % PS60 concentration. It can, however, not be determined from these data if there would be a further reduction in the volume-averaged diameter on using yet more of the emulsifier.

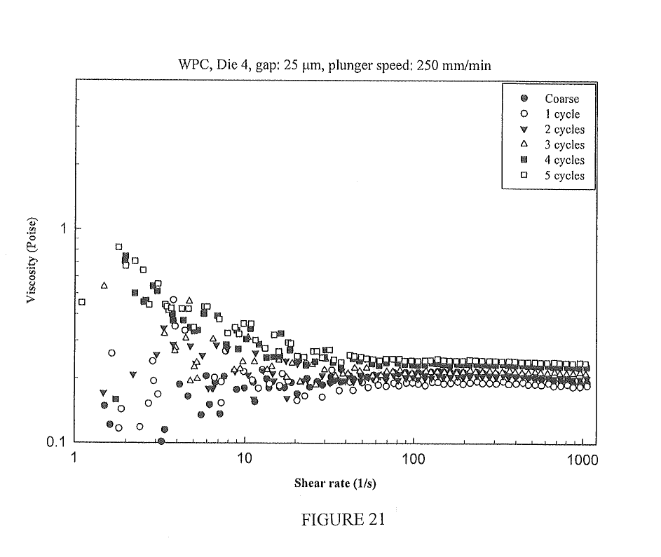

It has been mentioned earlier that the dispersed phase size depends on the plunger speed or equivalently the flow rate through the cell since this affects the stretch rate witnessed by the emulsion. This aspect was explored using Die 4 at a gap of 25 μm and a plunger speed=250 mm/min. The advantage of a lower plunger speed is the reduction in the energy that is input to the emulsion. Results for the measured dispersed phase sizes are listed in Table 8 which also shows the influence of fluid recirculation. Clearly there is size reduction, but the effect of recirculation on particle size reduction is much less as compared to what was observed at the plunger speed of 500 mm/min (see FIG. 17), The viscosity measurements are shown in FIG. 21, and these are consistent with the larger droplet sizes.

The process of scaling up of the extensional flow mixer to yield emulsion flow rates as high as 1736 cc/min was carried out successfully. A key advantage of the larger sized extensional flow mixing system of this invention (Die 5, FIG. 15) is that all dimensions are known with precision, and the gaps between the mixer wall and the insert can be set with accuracy. Also, fabricating the mixer is very easy. Experiments were carried out at a fixed gap of 25 μm between the cone wall and the spherical insert. Three different plunger speeds (or flow rates) were used, and results for the volume-average and number-average diameters are given in Table 9. It can be seen that the volume-averaged droplet size decreases progressively with increasing flow rate, and the smallest drop size is obtained at the highest flow rate. The number-averaged drop diameter, however, does not appear to change with increasing flow rate. As a consequence, the polydispersity index reduces with increasing flow rate. Passing the emulsion once more through the flow cell results in a further reduction in the volume-averaged diameter. However, the number-averaged size actually increases. This suggests that the large drops were broken down but the small drops coalesced upon recycling. This, however, does imply that there was a significant narrowing of the droplet size distribution.

The comparison of the volume-average diameter obtained using Die 5 at a gap of 25 μm and Die 2, also at a gap of 25 μm, is shown in Table 10. For Die 2, the maximum flow rate through the piston pump was used. It can be seen that the drop sizes in the two cases are very similar. Thus, we can conclude that we are able to obtain the same performance after scaling up of the flow cell. It should be mentioned that, in the absence of an insert, identical stretch rates would be obtained in the two cases when the flow rate in the larger cell is set to eight times that in the smaller cell. Here the ratio used ranges from 2.75 to 4.57. However, most of the stretching takes place in the narrow gap between the sphere and the cone wall, and, therefore, different combinations of the gap and flow rate are likely to yield similar results. These results suggest that the process of further scaling up could be carried out yet again. In such a situation, machining of the flow cell should become easier still, and the throughput would be further enhanced toward realistic production values.

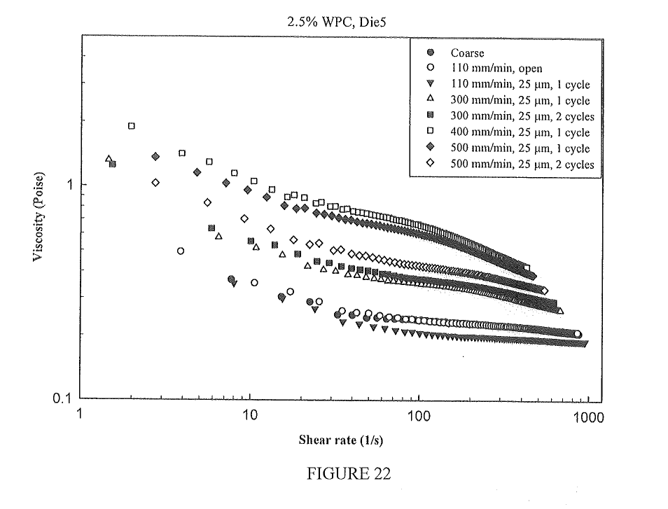

The measured viscosity values of the emulsions prepared using Die 5 are presented in FIG. 22. Note that the viscosity of the emulsion obtained, whether using a large gap or a small gap, at a plunger speed of 110 mm/min is almost the same as that of the coarse emulsion. This is because there is no size reduction on making the coarse emulsion go through the flow cell under these conditions. By contrast, flow curves of emulsions made at plunger speeds of 300 mm/min or more lie above the flow curve of the coarse emulsion. However, the trend with multiple cycling and plunger speed is not absolutely clear, and this is similar to the behavior reported earlier with emulsions made using the smaller flow cell, Die 2.

Finally, the effect of the presence of foams entrained in the emulsions during recycling was investigated. When the coarse emulsion is run through the flow cell, the resulting fine emulsion contains some entrained foam. If this product is immediately recycled, the foam is also incorporated in the subsequent emulsions that are formed. The dispersed phase sizes obtained when the fine emulsions were passed through the mixer repeatedly were compared with the situation when each emulsion was allowed to rest for 24 hours prior to being recirculated; waiting for 24 hours allows the foam to subside. No significant differences were detected. This suggests that this process can be carried out continuously without worrying about any adverse effect of air entrapped in the system.

### Computational Results

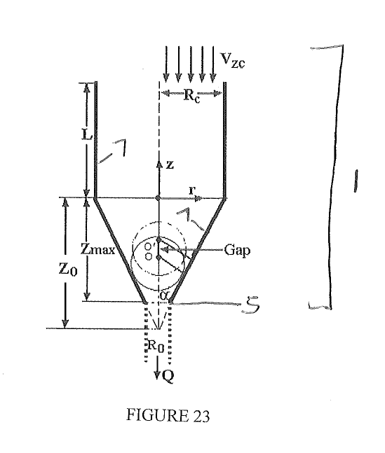

With the help of COMSOL software, computations were done to simulate the flow of a Newtonian liquid around a sphere in a cone, as shown in FIG. 23. When the center of the sphere is located at the position marked “O”, there is no gap between the sphere and the flow cell wall, i.e., the flow is completely blocked. Once the center of the sphere moves to position O′, there exists a gap between the sphere and the wall. Here, the gap refers to the distance between O and O′. Notice that in the real situation, the sphere is attached to the end of a micrometer to allow for a means to change the gap. Also, the fluid enters the flow cell from the side wall. Here, in order to simply the computations, it is assumed that the liquid enters from the top and has a flat velocity profile.

The dimensions of the flow cell and of the sphere are:

$$L = 9.525 mm , {R}_{c} = {0.375}^{″} = 9.525 mm , \\ {R}_{0} = {0.00675}^{″} = 0.17145 mm , \\ {Z}_{0} = \frac{{R}_{c}}{tan α} = {0.375}^{″} = 9.525 mm$$

The diameter of the sphere is 5.9 mm, and the diameter of the plunger is 31.6 mm.

The impacts of gap setting, plunger speed and fluid viscosity on the force exerted on the plunger and the stretch rates in the flow field were investigated by solving the Navier-Stokes equation. The plunger speed was varied from 182 mm/min to 500 mm/min, while the viscosity was set at levels of 50 cp, 20 cp and 2 cp. It is worth mentioning that when the gap became smaller, it was more difficult to get convergent solutions.

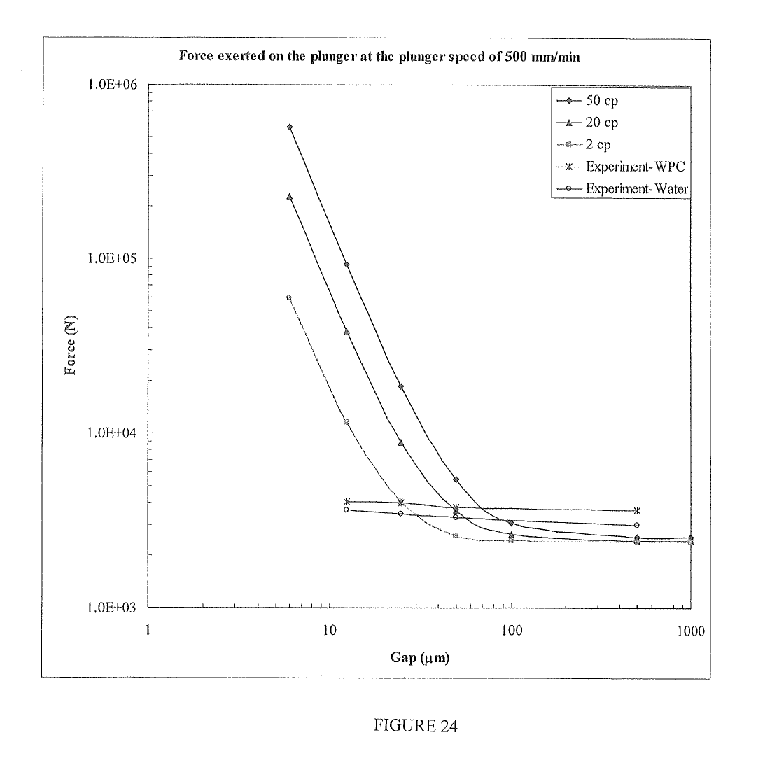

As expected, the liquid undergoes acceleration when it approaches the narrowest gap. Then it experiences deceleration once it goes past the narrowest gap. Finally, it undertakes acceleration again when it leaves the orifice at the exit of the cell. The computed force needed to make the liquid flow through the cell is plotted in FIG. 24 as a function of the gap setting. FIG. 24 shows the following information:

1. When the gap is larger than a certain value, which depends on the viscosity, the calculated force is almost independent of the gap setting.

2. Once the gap is below the critical value, the calculated force increases drastically with a decrease in the gap setting.

3. As expected, the larger the viscosity, the larger is the measured force exerted on the plunger.

4. At large gaps, computational results are smaller than the experimental values. In contrast, at lower gaps, calculated values are much larger than the experimental ones. This implies that the real gap is larger than what is set. This was corroborated by the fact that flow still occurred when the gap was set to zero. Simultaneously, based on the value of the force measured, one can estimate that the real minimum gap is of the order of 20˜30 microns due to the presence of asperities between the sphere and the flow cell wall. The mismatch between the computed and measured forces at large gaps may be due to either because the liquid comes from the side wall rather than from the top at a uniform velocity profile or because the sphere attached at the end of the micrometer is not exactly a sphere.

The relative amounts of shear and extension as function of the gap setting are given in Table 11. It is seen that extensional flow in the flow cell is dominant.

TABLE 1
Mean size and polydispersity index using Die 2 at a gap of 25 μm
and plunger speed of 500 mm/min

| | Volume-average | Number-average diameter, | Polydispersity |
|---|---|---|---|
| | diameter, D̅ᵥ (μm) | D̅ₙ (μm) | index D̅ᵥ/ D̅ₙ |
| 1 cycle | 4.000 | 0.895 | 4.5 |
| 2 cycles | 2.799 | 0.602 | 4.6 |
| 3 cycles | 2.231 | 0.597 | 3.7 |
| 4 cycles | 2.073 | 0.601 | 3.4 |

TABLE 2
Mean size and polydispersity index using Die 4 at a gap of 25 μm
and plunger speed of 500 mm/min

| | Volume-average | Number-average diameter, | Polydispersity |
|---|---|---|---|
| | diameter, D̅ᵥ (μm) | D̅ₙ (μm) | index D̅ᵥ/ D̅ₙ |
| 1 cycle | 3.626 | 0.499 | 7.3 |
| 2 cycles | 2.841 | 0.666 | 4.3 |
| 4 cycles | 1.842 | 0.608 | 3.0 |
| 5 cycles | 1.715 | 0.592 | 2.9 |

TABLE 3
Mean size and polydispersity index using Die 4 at a gap of 50 μm
and plunger speed of 500 mm/min

| | Volume-average | Number-average diameter, | Polydispersity |
|---|---|---|---|
| | diameter, D̅ᵥ (μm) | D̅ₙ (μm) | index D̅ᵥ/ D̅ₙ |
| 1 cycle | 3.606 | 0.511 | 7.1 |
| 2 cycles | 2.429 | 0.594 | 4.1 |
| 3 cycles | 1.965 | 0.651 | 3.0 |
| 4 cycles | 1.825 | 0.912 | 2.0 |
| 5 cycles | 1.717 | 0.904 | 1.9 |

TABLE 4
Mean size and polydispersity index using Die 2 at zero gap and
plunger speed of 500 mm/min (2.5%)

| | Volume-average | Number-average diameter, | Polydispersity |
|---|---|---|---|
| | diameter, D̅ᵥ (μm) | D̅ₙ (μm) | index D̅ᵥ/ D̅ₙ |
| 1 cycle | 4.550 | 1.474 | 3.1 |
| 2 cycles | 3.079 | 0.61 | 5.0 |
| 3 cycles | 2.452 | 0.78 | 3.1 |
| 4 cycles | 2.108 | 0.954 | 2.2 |

TABLE 5
Mean size and polydispersity index using Die 2 at zero gap and
plunger speed of 500 mm/min (3.5%)

| | Volume-average | Number-average diameter, | Polydispersity |
|---|---|---|---|
| | diameter, D̅ᵥ (μm) | D̅ₙ (μm) | index D̅ᵥ/ D̅ₙ |
| 1 cycle | 3.346 | 0.477 | 7.0 |
| 2 cycles | 2.881 | 0.557 | 5.2 |
| 3 cycles | 1.991 | 0.886 | 2.2 |
| 4 cycles | 1.8 | 0.865 | 2.1 |

TABLE 6
Mean size and polydispersity index using Die 2 at zero gap and
plunger speed of 500 mm/min (5.0%)

| | Volume-average | Number-average diameter, | Polydispersity |
|---|---|---|---|
| | diameter, D̅ᵥ (μm) | D̅ₙ (μm) | index D̅ᵥ/ D̅ₙ |
| 1 cycle | 4.077 | 0.949 | 4.3 |
| 2 cycles | 2.022 | 0.592 | 3.4 |
| 3 cycles | 1.715 | 0.859 | 2.0 |
| 4 cycles | 1.298 | 0.574 | 2.3 |

TABLE 7
Mean size and polydispersity index of emulsions prepared
using Die2 at zero gap and plunger speed of 500 mm/min
(Polysorbate 60)

| | Volume-average | | | Number-average | | | Polydispersity | | |
|---|---|---|---|---|---|---|---|---|---|
| | diameter, | | | diameter, | | | index | | |
| | D̅ᵥ (μm) | | | D̅ₙ (μm) | | | D̅ᵥ/ D̅ₙ | | |
| | 0.5% | 1% | 2% | 0.5% | 1% | 2% | 0.5% | 1% | 2% |
| 1 cycle | 3.032 | 4.02 | 3.116 | 0.434 | 0.457 | 0.45 | 7.0 | 8.8 | 6.9 |
| 2 cycles | 3.918 | 3.21 | 3.022 | 0.466 | 0.622 | 0.684 | 8.4 | 5.2 | 4.4 |
| 3 cycles | 3.356 | 2.715 | 2.296 | 0.499 | 0.649 | 0.589 | 6.7 | 4.2 | 3.9 |
| 4 cycles | 3.438 | 2.365 | 2.034 | 0.664 | 0.988 | 0.9 | 5.2 | 2.4 | 2.3 |

TABLE 8
Mean size and polydispersity index using Die 4 at a gap of 25 μm and
plunger speed of 250 mm/min

| | Volume-average | Number-average diameter, | Polydispersity |
|---|---|---|---|
| | diameter, D̅ᵥ (μm) | D̅ₙ (μm) | index D̅ᵥ/ D̅ₙ |
| 1 cycle | 3.032 | 0.438 | 6.9 |
| 5 cycles | 3.434 | 0.571 | 6.0 |

TABLE 9
Mean droplet size and polydispersity index obtained using
Die 5 at a gap of 25 μm (2.5% WPC)

| | | Volume- | | Number- | | Poly- | |
|---|---|---|---|---|---|---|---|
| | | average | | average | | dispersity | |
| | | diameter, | | diameter, | | index | |
| Plunger | Flow | D̅ᵥ (μm) | | D̅ₙ (μm) | | D̅ᵥ/ D̅ₙ | |
| Speed | rate | 1 | 2 | 1 | 2 | 1 | 2 |
| mm/min | (cc/min) | cycle | cycles | cycle | cycles | cycle | cycles |
| 300 | 1041.9 | 3.946 | 3.411 | 0.466 | 0.522 | 8.5 | 6.5 |
| 400 | 1389.3 | 3.577 | — | 0.483 | — | 7.4 | — |
| 500 | 1736.6 | 3.465 | 2.826 | 0.485 | 0.761 | 7.1 | 3.7 |

TABLE 10
Comparison of volume-mean diameter using Die 5 (scale up) and Die 2

| | Die 2 (gap = 25 (μm) | Die 5 (gap = 25 (μm) | | |
|---|---|---|---|---|
| Number of | Flow rate (cc/min) | Flow rate (cc/min) | | |
| recycle | 379.8 (maximum) | 1041.9 | 1389.3 | 1736.6 |
| 1 | 4.000 | 3.946 | 3.577 | 3.465 |
| 2 | 2.799 | 3.411 | — | 2.826 |
| 3 | 2.231 | — | — | — |
| 4 | 2.073 | — | — | — |

TABLE 11
Viscous dissipation and its components at the plunger speed of 500 mm/min

| | | Total viscous | Extensional | Shear | Force on | |
|---|---|---|---|---|---|---|
| Gap | Viscosity | dissipation | component | component | the plunger | Pressure |
| (μm) | (Pa · s) | (Watt) | (Watt) | (Watt) | (N) | MPa/PSI |
| No | 0.02 | 0.942 | 0.85 (90.2%) | 0.092 | 2491 | 3.176/461 |
| sphere | | | | | | |
| 1000 | 0.02 | 0.975 | 0.884 (90.7%) | 0.091 | 2445.6 | 3.118/452 |
| 500 | 0.02 | 0.999 | 0.907 (90.8%) | 0.092 | 2444.8 | 3.117/452 |
| 100 | 0.02 | 2.644 | 2.516 (95.2%) | 0.128 | 2645.7 | 3.373/489 |
| 50 | 0.02 | 10.383 | 10.18 (98.0%) | 0.203 | 3582.6 | 4.568/663 |
| 25 | 0.02 | 53.98 | 53.56 (99.2%) | 0.42 | 8869.5 | 11.309/1640 |
| 12.5 | 0.02 | 300.136 | 299.1 (99.7%) | 1.036 | 38717.7 | 49.368/7160 |
| 6 | 0.02 | 1872.649 | 1869.7 (99.8%) | 2.949 | 229406.9 | 292.5/42424 |

### Example III

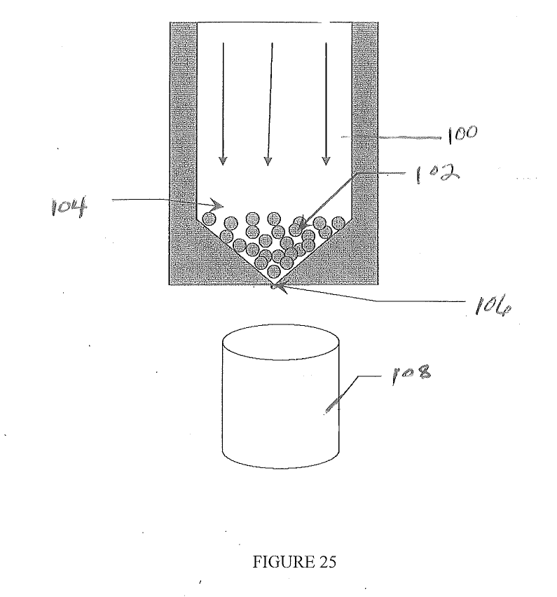

FIG. 25 shows another embodiment of the extensional flow mixing system of the present invention. FIG. 25 shows a schematic diagram of the extensional flow mixing device comprising a (partially) packed converging channel (100) that is packed with a packing material (102) (as described hereinbefore). The three downward arrows placed in the converging channel (100) represent the direction of the coarse emulsion flow within the converging channel (100). A conical extension flow region (104) of the converging channel (100) is also shown in FIG. 25. The converging channel's (100) conical extension flow region (104) has an orifice (opening) (106) as shown in FIG. 25. The device optionally has a collection container (108) positioned in juxtaposition to the orifice (106) for collection of treated (fine) emulsion.

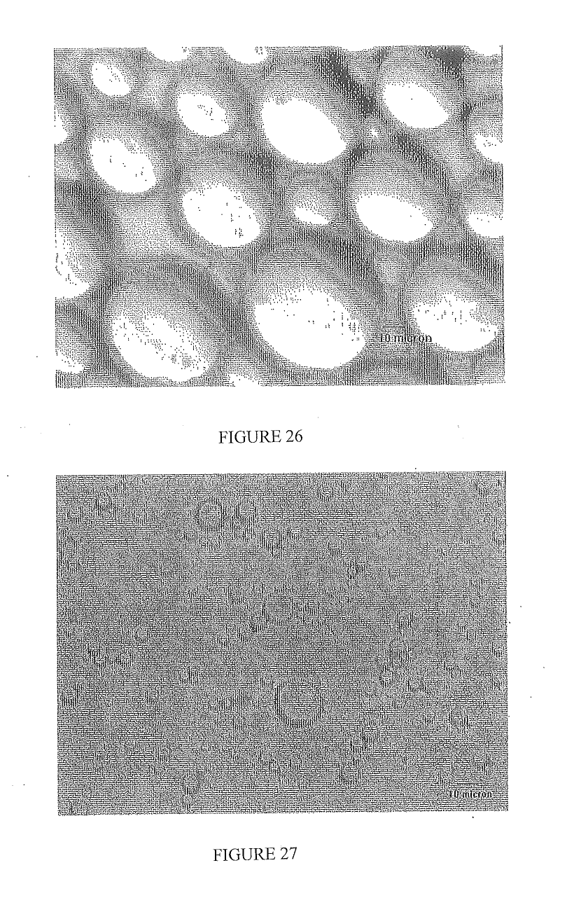

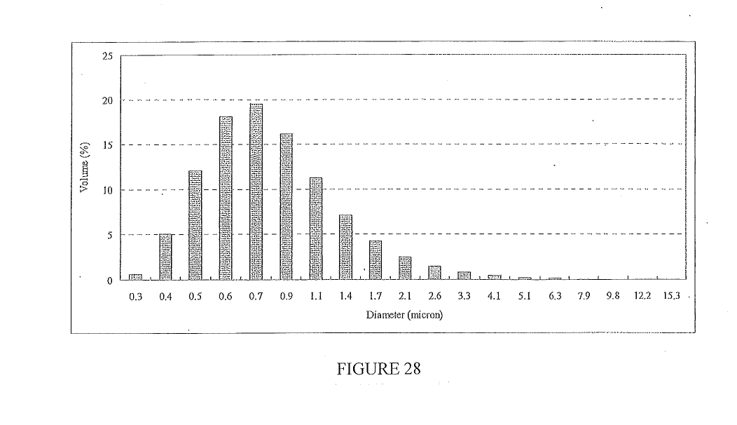

FIG. 26 shows an untreated (coarse) emulsion of oil-in-water (volume average diameter of about 30 μm. FIG. 27 shows the treated (fine) emulsion of oil-in-water after passage of the coarse emulsion through the extensional flow mixing device of this invention (volume average diameter is about 0.7 μm. FIG. 28 shows particle size distribution of treated (fine) emulsion after one passage through the extensional flow mixing device of this invention (volume average diameter is about 0.705 μm.

While we have shown and described certain present preferred embodiments of the extensional flow mixing device, and have set forth certain present preferred methods of making and using the device, it is to be understood that the invention is not limited thereto. Whereas particular embodiments of this invention have been described above for purposes of illustration, it will be evident to those persons skilled in the art that numerous variations of the details of the present invention may be made without departing from the invention as defined herein and in the appended claims.

We claim:

1. An extensional flow mixing device comprising:
a cell including an inlet for introducing fluid into the cell and an outlet permitting fluid to flow out of the cell, the cell having an interior surface defining a convergent flow path that has an internal cross-sectional area that decreases from the inlet to the outlet so as to define a direction of convergence from the inlet to the outlet;
an insert extending within the cell in the direction of convergence, the insert comprising a protuberance which causes the fluid to undergo an extensional episode;
wherein the protuberance is spaced from the interior surface by a dimension “α” that is constant or changes gradually in the direction of convergence.

2. The extensional flow mixing device of claim 1, wherein the protuberance is generally spheroidal, and wherein α is between about 15μ and about 40μ.

3. The extensional flow mixing device of claim 2, further comprising a second protuberance which causes the fluid to undergo a second extensional episode, wherein the second protuberance has different geometry from the first protuberance and causes fluid in the cell to converge and diverge with a different flow pattern than the other protuberance, and wherein the second protuberance is spaced from the interior surface by a dimension “β” and comprises an angled edge on a portion of the protuberance that is closest to the interior surface.

4. The extensional flow mixing device of claim 1, wherein the protuberance has a generally conical outer surface that is spaced from the interior surface of the cell by a dimension that is substantially constant.

5. The extensional flow mixing device of claim 2, defining a flow cross-section ratio of between about 100 to about 5000.

6. The extensional flow mixing device of claim 3, wherein each protuberance is independently adjustable to control α and β, and thereby control flow cross-section ratio for each protuberance.

7. An extensional flow mixing device for preparing dispersions, comprising:
a cell including an inlet for introducing fluid into the cell and an outlet permitting fluid to flow out of the cell, the cell having a convergent portion that has an internal cross-sectional area that decreases from the inlet to the outlet so as to define a direction of convergence from the inlet to the outlet;
an insert including a distal end extending within the cell in a direction of convergence, the distal end of the insert comprising a plurality of protuberances, each of the protuberances causing fluid in the cell to undergo an extensional episode as the fluid encounters the protuberance, each protuberance defining a space between an interior surface of the cell and the protuberance, each of the protuberances producing a different diverging and converging fluid flow pattern.

8. The extensional flow mixing device of claim 7 wherein each protuberance is independently adjustable such that a size of the space defined by each protuberance and the interior surface of the cell may be independently adjusted, and wherein the protuberances are of different shapes.

9. The extensional flow mixing device of claim 7 wherein at least one protuberance is rounded on a portion of the protuberance that is closest to the interior surface, and one protuberance has an angled edge on a portion of the protuberance that is closest to the interior surface.

10. The extensional flow mixing device of claim 9 wherein the protuberances are curved and one protuberance has a larger radius of curvature than the other.

11. The extensional flow mixing device of claim 10 having a flow cross-section ratio of between about 100 to about 5000.

12. A method of providing extensional flow comprising the steps of:
providing a cell including an inlet for introducing fluid into the cell and an outlet permitting fluid to flow out of the cell, the cell having a convergent portion that has an internal cross-sectional area that decreases from the inlet to the outlet so as to define a direction of convergence from the inlet to the outlet;
providing an insert including a distal end extending within the cell in a direction of convergence, the distal end of the insert comprising a plurality of protuberances each defining a space between an interior surface of the cell and the protuberance;
introducing at least one fluid into the cell; and
providing extensional episodes to the fluid in the cell as fluid flows past the protuberances, each of the protuberances producing a different diverging and converging fluid flow pattern; and
providing an additional extensional episode at the outlet for providing extensional flow.

13. The method of claim 12, wherein the fluids are immiscible liquids.

14. The method of claim 12, wherein the fluids are at least one gas and one liquid.

15. The method of claim 12, further comprising the step of dispersing a solid within the at least one fluid.

16. The method of claim 12, further comprising the step of adjusting the protuberances to control spacing between the protuberances and the interior surface of the cell.

17. The method of claim 12, further comprising the step of adjusting each protuberance independently to control spacing between each protuberance and the interior surface of the cell.

18. A method of providing extensional flow for preparing edible emulsions, comprising the steps of:
providing a cell including an inlet for introducing fluid into the cell and an outlet permitting fluid to flow out of the cell, the cell having a convergent portion that has an internal cross-sectional area that decreases from the inlet to the outlet so as to define a direction of convergence from the inlet to the outlet;
providing an insert including a distal end extending within the cell in a direction of convergence, the distal end of the insert comprising a single protuberance defining an area between an interior surface of the cell and the protuberance;
introducing at least one fluid into the cell; and
providing an extensional episode as to the fluid in the cell as fluid flows past the protuberance for preparing edible emulsions.

19. The method of claim 18, wherein the step of introducing at least one fluid comprises introducing at least two immiscible liquids.

20. The method of claim 18, wherein the step of introducing at least one fluid comprises introducing at least one gas and one liquid.

21. The method of claim 18, further comprising the step of dispersing a solid within the at least one fluid.

22. The method of claim 18, further comprising the step of adjusting the protuberances to vary the area between the interior surface of the cell and the protuberance.

23. The method of claim 18, wherein the step of introducing at least one fluid into the cell comprises introducing a coarse edible oil-in-water emulsion comprising at least about 50% edible oil, and at least one edible emulsifier selected from one or more of polysorbate 60, whey protein, lecithin and egg yolk as an emulsifier.

24. The method of claim 18, wherein the step of introducing at least one fluid into the cell comprises introducing a coarse emulsion having an average volume-averaged initial droplet size of between about 10 μm and about 100 μm, and wherein the method comprises repeatedly providing extensional episodes involving forcing the at least one fluid through a gap of between about 15 μm and about 60 μm to reduce volume-averaged initial droplet size to below 2 μm while also increasing viscosity.

25. The method of claim 19, wherein the cell has a conical interior and the insert comprises a substantially spheroidal surface, and wherein the at least one fluid is subjected to a total extensional (Hencky) strain of up to eight in a flow dominated by extension and not by shear, at a flow rate of at least about 1.7 liters/min.
